(19) United States
(12) Patent Application Publication
(10) Pub. No.: US 2012/0216394 A1
(43) Pub. Date: Aug. 30, 2012

(54) METHOD FOR PRODUCING SOLID ELECTROLYTE BATTERY

(75) Inventors: Masayuki Kitaura, Toyota-shi (JP); Hirokazu Kawaoka, Nisshin-shi (JP)

(73) Assignee: TOYOTA JIDOSHA KABUSHIKI KAISHA, Toyota-shi, Aichi (JP)

(21) Appl. No.: 13/505,133

(22) PCT Filed: Nov. 2, 2009
(86) PCT No.: PCT/JP2009/068776

§ 371 Date: Apr. 30, 2012

(51) Int. Cl. H01M 10/058

(52) U.S. Cl. 29/623.2

(57) ABSTRACT

A method for producing a solid electrolyte battery that makes it possible to prevent foreign substance attachment to an electrode unit and press the electrode unit uniformly. A method for producing a solid electrolyte battery in which an outer case houses at least one electrode cell that has an electrode unit comprising at least a positive electrode layer, a solid electrolyte layer and a negative electrode layer stacked in this order, the method including the steps of: inserting the electrode cell in the outer case before pressing the electrode cell in a stacking direction in the electrode unit, and pressing the electrode cell from the outside of the outer case in the stacking direction in the electrode unit.

### TECHNICAL FIELD

The present invention relates to a method for producing a solid electrolyte battery.

### BACKGROUND ART

In recent years, with the rapid spread of IT- and communication-related devices such as personal computers, camcorders and cellular phones, much attention has been focused on the development of batteries which are used as their power sources. Also in the automobile industry, high-power and high-capacity batteries for electric vehicles and hybrid vehicles are under development. Among various kinds of secondary batteries, a lithium secondary battery is drawing attention due to its high energy density and high power output.

However, a lithium secondary battery that is now mainstream uses a combustible organic solvent as the electrolytic solution; therefore, it is needed to have safety measures against leakage, short circuit, overcharge, etc. To improve safety, development of solid-state lithium secondary batteries using as the electrolyte a solid electrolyte such as an ion conductive polymer or ceramics, have been promoted (for example, see Patent Literature 1). As the ceramics which is usable as a lithium ion conductive solid electrolyte, especially, an oxide-based inorganic solid electrolyte and a sulfide-based inorganic solid electrolyte are attracting attention.

A solid-state battery exemplified by a solid-state lithium secondary battery generally comprises an electrode unit in which a positive electrode layer and a negative electrode layer are stacked through a solid electrolyte layer. A solid-state battery comprises one electrode unit or a stack of electrode units, depending on desired battery properties.

In a solid-state battery, each of the positive and negative electrode layers is formed with an electrode active material only, or with a solid electrolyte for providing ion conductivity to the electrode, a conductive additive for ensuring conductivity, a binder for providing flexibility to the electrode layer, etc., in addition to an electrode active material. The solid electrolyte layer is formed with a solid electrolyte only, or with a binder for providing flexibility to the solid electrolyte layer, etc., in addition to a solid electrolyte.

As the method for producing each layer of the electrode unit, for example, there may be mentioned pressure-forming an electrode material powder by a powder-molding method, the powder being obtained by mixing an electrode active material with a solid electrolyte, a conductive additive, etc., as needed. As the method for producing a solid electrolyte layer, for example, there may be mentioned pressure-forming an electrolyte material powder by a powder-molding method, the powder being obtained by mixing a solid electrolyte with materials such as a binder, as needed.

Methods other than the powder molding method include a method for producing each electrode or a solid electrolyte layer by applying a paste onto a surface of a substrate (such as a removable substrate, a current collector or an electrode) and drying the same, the paste being prepared by dispersing the electrode material powder or electrolyte material powder in a solvent.

The positive electrode layer, electrolyte layer and negative electrode layer produced in such a manner are generally pressed or heated and pressed in the state of being stacked in this order. For example, in Patent Literature 1, a solid-state cell (electrode unit) is produced by stacking a positive electrode composite layer, a solid electrolyte layer and a negative electrode composite layer and pressing the stack, the positive electrode composite layer being produced by pressing and sintering a mixture of a sulfide glass, a positive electrode active material and a conductive additive, the solid electrolyte layer being produced by pressing and sintering a sulfide glass, and the negative electrode composite layer being produced by pressing and sintering a mixture of a sulfide glass and a negative electrode active material.

### CITATION LIST

Patent Literature 1: Japanese Patent Application Laid-Open No. 2008-270137

### SUMMARY OF INVENTION

### Technical Problem

In the case of employing the solid-state battery production method of Patent Literature 1 on a mass production line of solid-state batteries, there is such a problem that when pressing a stack of a positive electrode layer, an electrolyte layer and a negative electrode layer (that is, an electrode unit), some of the constituents of the electrode unit are detached from the electrode layers or electrolyte layer and attach to the pressing surface of a pressing machine. When a substance is attached to the pressing surface, the electrode unit is then non-uniformly pressed, resulting in a decrease in battery performance of the electrode unit. When the attached substance is a conductive material, there is such a problem that due to the attachment of the substance to the electrode unit to be pressed, a small short circuit occurs in the electrode unit, resulting in a decrease in battery performance.

The present invention was achieved in light of the above-stated circumstances. An object of the present invention is to provide a solid electrolyte battery production method which enables prevention of foreign substance attachment to the electrode unit and also enables pressing the electrode unit uniformly.

### Solution to Problem

The method for producing a solid electrolyte battery of the present invention is a method for producing a solid electrolyte battery in which an outer case houses at least one electrode cell that has an electrode unit comprising at least a positive electrode layer, a solid electrolyte layer and a negative electrode layer stacked in this order, the method comprising the steps of: inserting the electrode cell in the outer case before pressing the electrode cell in a stacking direction in the electrode unit, and pressing the electrode cell from the outside of the outer case in the stacking direction in the electrode unit.

In the solid electrolyte battery production method of the present invention, the electrode cell containing the electrode unit is pressed in the state of being inserted in the outer case, so that it is possible to prevent the electrode unit constituents detached from the electrode unit from attachment to the pressing surface of a pressing machine. According to the present invention, therefore, it is possible to press the electrode unit uniformly and to prevent foreign substance attachment to the electrode unit, thereby making it possible to increase the performance of a solid electrolyte battery.

In the case where the electrode cell comprises a stack of the electrode units, pressing a plurality of electrode units constituting the stack can be performed at once; therefore, it is possible to decrease the number of solid electrolyte battery production steps and thus to increase solid electrolyte battery productivity.

In the solid electrolyte battery production method of the present invention, preferably, the electrode cell is pressed and at the same time heated in the pressing step. This is because the constituents of the electrode unit are softened, thus increasing the adhesion between the layers constituting the electrode unit and also increasing the ion conductivity and electrical conductivity of the layers.

In the case where the electrode cell is pressed and at the same time heated in the pressing step, the pressing step can double as a step of sealing the outer case. This is because it is possible to seal the outer case by thermofusion by heating in the pressing step. By allowing the pressing step to double as the sealing step, it is possible to decrease the number of the solid electrolyte battery production steps and thus to increase solid electrolyte battery productivity.

The solid electrolyte battery production method of the present invention can further comprise a step of sealing the outer case between the inserting step and the pressing step. By sealing the electrode cell-housing outer case before the pressing step, it is possible to prevent in the pressing step the constituents of the electrode unit from reacting with moisture, etc., in the external environment of the outer case.

Preferably, a heat-resistant member which prevents the electrode cell from reaching a heating temperature in the sealing step, is present between the outer case and the electrode cell. By providing the heat-resistant member in this way, it is possible to prevent a decrease in the performance of the electrode cell, such as a deterioration in the electrode unit, due to the heating temperature in the sealing step.

### Advantageous Effects of Invention

According to the present invention, it is possible to prevent foreign substance attachment to the electrode unit and to press the electrode unit uniformly in the step of pressing the electrode cell. Therefore, it is possible to prevent a decrease in battery performance due to foreign substance attachment to the electrode unit or due to pressing the electrode unit non-uniformly. In the case where the pressing step doubles as the step of sealing the outer case, it is possible to decrease the number of battery production steps and thus to increase battery productivity.

### BRIEF DESCRIPTION OF DRAWINGS

FIG. 1 is a view showing an embodiment of the pressing step of the method for producing a solid electrolyte battery according to the present invention.

FIG. 2 shows an electrode cell shown in FIG. 1.

FIG. 3 is a view showing an example of the arrangement of a heat-resistant member in the method for producing a solid electrolyte battery according to the present invention.

FIG. 4 is a flowchart showing an embodiment of the method for producing a solid electrolyte battery according to the present invention.

FIG. 5 is a view showing an example of the production of a stack in the method for producing a solid electrolyte battery according to the present invention.

FIG. 6 is a view showing a different embodiment of the pressing step of the method for producing a solid electrolyte battery according to the present invention.

FIG. 7 is a view showing a different embodiment of the pressing step of the method for producing a solid electrolyte battery according to the present invention.

### DESCRIPTION OF EMBODIMENTS

The solid electrolyte battery production method of the present invention is a method for producing a solid electrolyte battery in which an outer case houses at least one electrode cell that has an electrode unit comprising at least a positive electrode layer, a solid electrolyte layer and a negative electrode layer stacked in this sequence, the method comprising the steps of: inserting the electrode cell in the outer case before pressing the electrode cell in a stacking direction in the electrode unit, and pressing the electrode cell from the outside of the outer case in the stacking direction in the electrode unit.

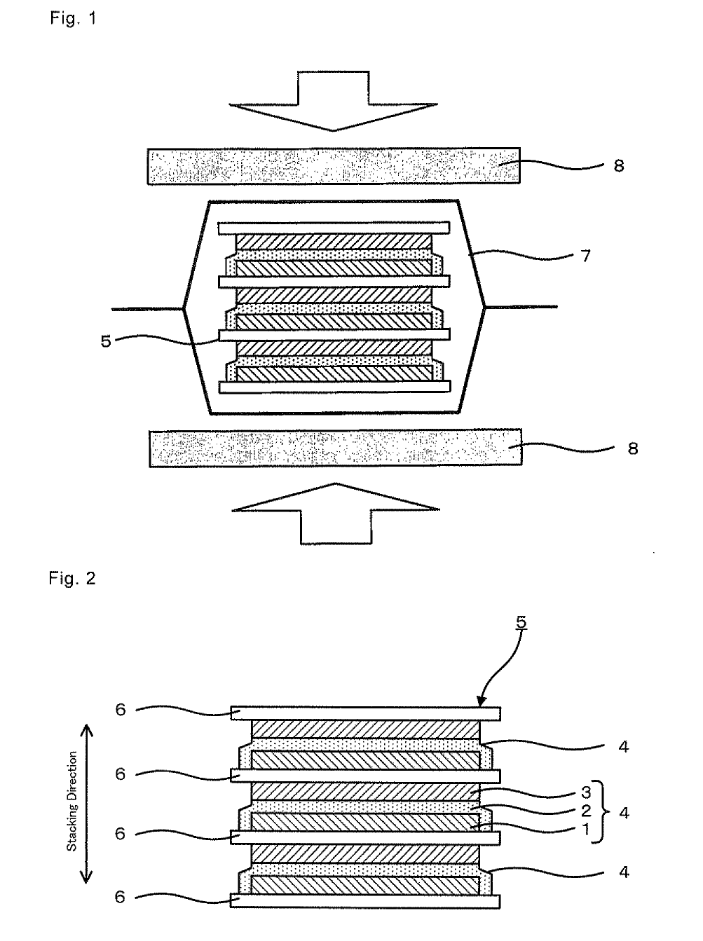

Hereinafter, the method for producing a solid electrolyte battery according to the present invention, will be explained by way of FIGS. 1 to 7. FIG. 1 is a schematic view showing an embodiment of the pressing step of the present invention. FIG. 2 is an enlarged view of an electrode cell shown in FIG. 1.

In FIG. 1, electrode cell 5 pressed by pressing machine 8 is inserted in an outer case 7. As shown in FIG. 2, electrode cell 5 comprises an electrode unit 4 comprising at least positive electrode layer 1, solid electrolyte layer 2 and negative electrode layer 3 stacked. Electrode cell 1 is pressed in the stacking direction of positive electrode layer 1, solid electrolyte layer 2 and negative electrode layer 3 (the direction indicated by an arrow shown in FIG. 2). Electrode cell 5 shown in FIG. 1 has stack 9 in which three electrode units 4 are stacked through two current collectors 6. Stack 9 is sandwiched between different two current collectors 6.

A main characteristic of the solid electrolyte battery production method of the present invention is such that an electrode cell that has an electrode unit in which a positive electrode layer, a solid electrolyte layer and a negative electrode layer stacked, is pressed in the state of being inserted in the outer case. As just described, by pressing the electrode unit in the state of being inserted in the outer case, it is possible to prevent the constituents of the electrode unit from detachment from the electrode layers (positive and negative electrode layers) or the solid electrolyte layer and thus adhering to the pressing surface of the pressing machine.

By the solid electrolyte battery production method of the present invention, as a result, it is possible to prevent problems which are generally caused in the step of pressing the electrode unit by the electrode unit constituents detached from the electrode unit and attached to the pressing surface of a pressing machine. That is, according to the present invention, it is possible to prevent the electrode unit from being pressed non-uniformly due to a foreign substance attached to the pressing surface. In the case where the foreign substance attached to the pressing surface contains a conductive material, when the conductive material attaches to an electrode unit which is to be pressed, a small short circuit is caused in the electrode unit by the conductive material. According to the present invention, however, it is possible to prevent the occurrence of a small short circuit. According to the present invention, therefore, it is possible to prevent a decrease in battery performance due to the above-described non-uniform pressing and small short circuit.

Hereinafter, the steps of the solid electrolyte production method of the present invention will be described in detail.

### (1) Inserting Step

The inserting step is a step of inserting the electrode cell having the electrode unit in the outer case before pressing the electrode cell in the stacking direction in the electrode unit. A step of sealing the outer case (sealing step) is employed separately from the inserting step.

The outer case, in which the electrode cell will be inserted, is not particularly limited as long as the electrode cell can be inserted therein and housed after sealing the outer case. For example, there may be mentioned one comprising an outer case material which is usable as the outer case of a lithium secondary battery.

In particular, for example, there may be mentioned an outer case which is formed with a laminate film having a multilayered structure such as outer resin layer/metal layer/thermally-weldable resin layer, outer resin layer/paper/thermally-weldable resin layer or outer resin layer/thermally-weldable resin layer. In the laminate film, as the resin which forms the outer resin layer there may be mentioned nylon, polyethylene terephthalate and biaxially oriented polypropylene, for example. As the metal which forms the metal layer, there may be mentioned stainless steel, Cu, Ni, V, Al, Mg, Fe, Ti, Co, Zn, Ge, In and Li, etc. As the resin which forms the thermally-weldable resin layer, there may be mentioned polyethylene, low-density linear polyethylene, ethylene vinyl acetate copolymer, ethylene vinyl alcohol copolymer, non-oriented polypropylene, etc. As the resin which forms the thermally-weldable resin layer, considering the heating temperature of the below-described pressing step, the sequence of the pressing step and the sealing step, etc., it is needed to select one having an appropriate melting point.

In the case where the heating temperature in the sealing step of sealing the outer case, in which the electrode cell is inserted, is higher than the electrode cell-heating temperature of the pressing step, there is such a possibility that the heating temperature of the sealing step may have adverse effects on the electrode cell, such as a deterioration in the electrode unit. Especially in the case of using a sulfide-based solid electrolyte as described below as the solid electrolyte, since sulfide-based solid electrolytes are highly reactive, the solid electrolyte may be reacted with a binder or the like by the heating of the sealing step, thereby increasing battery resistance. It is possible to prevent a deterioration in the electrode cell or a reduction in the performance of the electrode cell due to excess hating of the electrode cell, by providing a heat-resistant member which prevents the electrode cell from reaching a heating temperature in the sealing step, between the outer case and the electrode cell to be inserted in the outer case.

The constituent of the heat-resistant member is not particularly limited as long as it can prevent the electrode cell from reaching the heating temperature in the sealing step, and common heat-resistant materials can be used to form the heat-resistant member. For example, there may be mentioned heat-resistant resins which have a property that is not softened at the heating temperature of the sealing step.

For example, specific heat-resistant resins include: aliphatic polyamides such as nylon 6 (melting point 222° C.), nylon 46 (melting point 290° C.) and nylon (melting point 262° C.); polyester resins such as polybutylene terephthalate (melting point 224° C.), polyethylene terephthalate (melting point 256° C.) and polycyclohexanedimethylene terephthalate (melting point 290° C.); and super engineering plastics such as polyether ether ketone (melting point 334° C.).

As the heat-resistant resin, there may be used commercially-available products such as semiaromatic polyamides including: RENY (product name, melting point 243° C.) manufactured by Mitsubishi Gas Chemical Company, Inc.; HT nylon (product name, melting point 290° C.) manufactured by Toray Industries, Inc.; Arlen (product name, melting point 320° C.) manufactured by Mitsui Chemicals, Inc.; Amodel (product name, melting point 312° C.) manufactured by Solvay Advanced Polymers K. K.; and Zytel HTN (product name, melting point 300° C.) manufactured by Dupont.

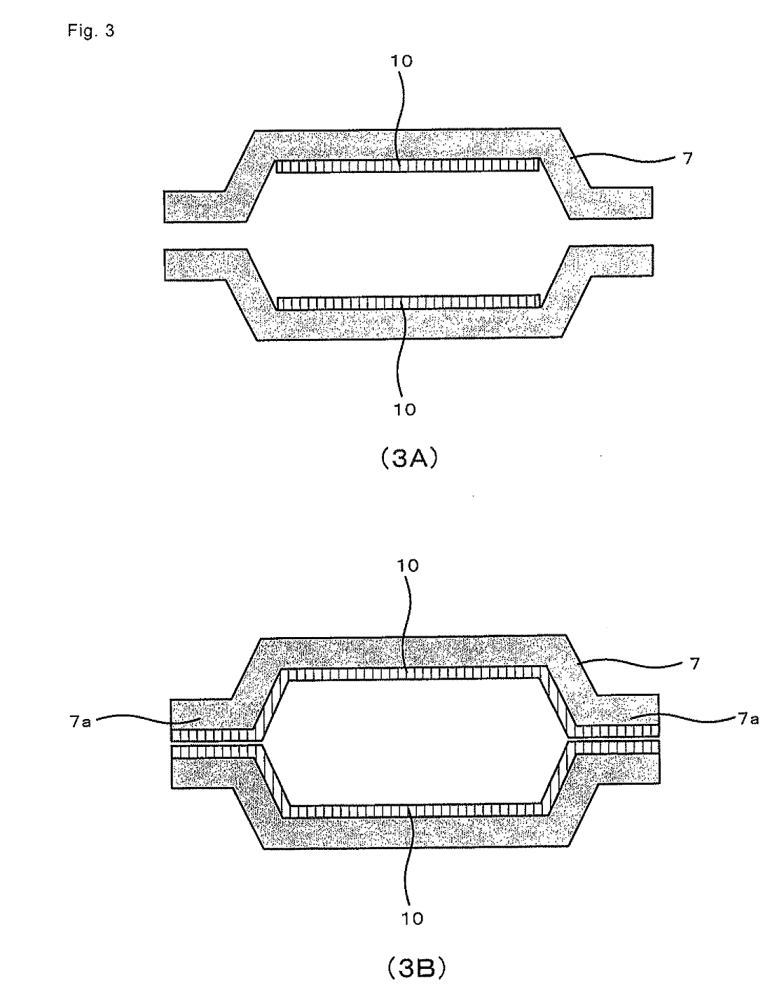

The method for arranging the heat-resistant member is not particularly limited and can be appropriately selected. In the case of arranging the heat-resistant member composed of a heat-resistant resin as described above, for example, as shown in FIG. 3, there may be mentioned a method for arranging heat-resistant resin film 10 in a corresponding position of the laminate film constituting outer case 7 or for applying heat-resistant resin 10 to a corresponding position. As shown in (3A) of FIG. 3, heat-resistant resin 10 can be arranged only in a position between outer case 7 and the electrode cell. Or, as shown in (3B) of FIG. 3, heat-resistant resin 10 can be also arranged in a sealing portion 7a of outer case 7 and used as a thermofusion resin to seal the outer case.

The electrode cell will be explained next, which will be inserted and housed in the outer case.

The electrode cell has at least one electrode unit comprising at least a positive electrode layer, a solid electrolyte layer and a negative electrode layer stacked in this order.

Each of the positive and negative electrode layers is only needed to contain at least an electrode active material. As the electrode active material, for example, there may be mentioned electrode active materials that can be used in lithium secondary batteries.

Electrode active materials that can be used in lithium secondary batteries include the following, for example: lithium cobaltate (LiCoO₂); lithium nickelate (LiNiO₂); Liᵢ₊ₓNi_{1/3}Mn_{1/3}Co_{1/3}O₂ (0≦x≦1); lithium manganate (LiMn₂O₄); different element-substituted Li-Mn spinel having a composition represented by Li₁₊ₓMn_{2-x-y}M_{y}O₄ (M is one or more kinds selected from the group consisting of Al, Mg, Co, Fe, Ni and Zn; 0≦x≦0.06; 0.03≦y≦0.15); lithium titanate (LiₓTiO_{y}, 0.36≦x≦2, 1.8≦y≦3); lithium metal phosphate (LiMPO₄, M is one or more kinds selected from the group consisting of Fe, Mn, Co and Ni); transition metal oxides such as vanadium oxide (V₂O₅) and molybdenum oxide (MoO₃); titanium sulfide (TiS₂); carbonaceous materials (C) such as graphite and hard carbon; lithium cobalt nitride (LiCoN); lithium silicon oxide (LiₓSi_{y}O_{z}, x+4y−2z=0); lithium metal (Li); lithium alloy (LiM, M is one or more kinds selected from the group consisting of Sn, Si, Al, Ge,Sb, P and so on); lithium storage intermetallic compound (MgₓM or N_{y}Sb; M is one or more kinds selected from the group consisting of Sn, Ge and Sb; and N is one or more kinds selected from the group consisting of In, Cu and Mn); and derivatives thereof.

Herein, there is no sharp distinction between positive and negative electrode active materials. A battery with a desired voltage can be produced by comparing of charge-discharge potentials of two kinds of compounds and combining one showing a noble potential as the positive electrode active material with the other showing a less noble as the negative electrode active material.

In addition to the electrode active material, each of the positive and negative electrode layers can contain a solid electrolyte, conductive additive, binder, etc., for the purpose of providing ion conductivity, electrical conductivity, flexibility, etc., to the electrode layer.

The solid electrolyte is not particularly limited as long as it can provide ion conductivity to the electrode layer. For example, there may be mentioned those described below as the solid electrolyte for constituting the solid electrolyte layer. The binder is not particularly limited as long as it can provide flexibility to the electrode layer. For example, there may be mentioned those described below as the binder for constituting the solid electrolyte layer.

The conductive additive is not particularly limited as long as it can provide electrical conductivity to the electrode layer. For example, those usable in lithium secondary batteries can be used. In particular, there may be mentioned electrically-conductive carbonaceous materials such as acetylene black, ketjen black, VGCF (vapor-grown carbon fiber) and carbon nanotubes, for example.

In the positive electrode layer, the ratio of the components constituting the positive electrode layer is not particularly limited. The positive electrode active material contained in the positive electrode layer is preferably 30 to 70 wt %, more preferably 45 to 55 wt % of the whole positive electrode layer. The solid electrolyte is preferably 30 to 70 wt %, more preferably 45 to 55 wt % of the whole positive electrode layer. The conductive additive is preferably 0.01 to 10 wt %, more preferably 5 to 10 wt % of the whole positive electrode layer. The binder is preferably 0.01 to 10 wt %, more preferably 0.1 to 1 wt % of the whole positive electrode layer.

In the negative electrode layer, the ratio of the components constituting the negative electrode layer is not particularly limited. The negative electrode active material contained in the negative electrode layer is preferably 30 to 70 wt %, more preferably 45 to 55 wt % of the whole negative electrode layer. The solid electrolyte is preferably 30 to 70 wt %, more preferably 45 to 55 wt % of the whole negative electrode layer. The conductive additive is preferably 0.01 to 10 wt %, more preferably 5 to 10 wt % of the whole negative electrode layer. The binder is preferably 0.01 to 10 wt %, more preferably 0.1 to 5 wt % of the whole negative electrode layer.

The thickness of the positive and electrode layers is not particularly limited. In general, it is preferably 10 to 500 μm.

The solid electrolyte layer is needed to contain at least a solid electrolyte. As the solid electrolyte, for example, there may be mentioned those usable in lithium secondary batteries. Specific examples of solid electrolytes of lithium secondary batteries include oxide-based, non-crystalline solid electrolytes such as Li₂O-B₂O₃-P₂O₅, Li₂O-SiO₂, Li₂O-B₂O₃ and Li₂O-B₂O₃-ZnO; sulfide-based, non-crystalline solid electrolytes such as Li₂S-SiS₂, LiI-Li₂S-SiS₂, LiI-Li₂S-P₂S₅, LiI-Li₂S-B₂S₃, Li₃PO₄-Li₂S-Si₂S, Li₃PO₄-Li₂S-SiS₂, LiI-Li₂S-P₂O₅, LiI-Li₃PO₄-P₂S₅ and Li₂S-P₂S₅; and crystalline oxide or oxynitride such as Lii, LiI-Al₂O₃, Li₃N, Li₃N-LiI-LiOH, Li_{1.3}Al_{0.3}Ti_{0.7} (PO₄)₃, Li_{i+x+y}AlₓTi₂₋ₓSi_{y}P_{3-y}O₁₂ (A is at least one kind selected from the group consisting of Al and Ga; 0≦c≦4; and 0≦y≦0.6), [(B_{1/2}Li_{1/2})_{1-z}C_{z}]TiO₃ (B is at least one kind selected from the group consisting of La, Pr, Nd and Sm; C is at least one kind selected from the group consisting of Sr and Ba; and 0≦z≦0.5), Li₅La₃Ta₂O₁₂, Li₇La₃Zr₂O₁₂, Li₆BaLa₂Ta₂O₁₂, Li₃PO_{(4-3/2w)}N_{w} (w<1) and Li_{3.6}Si_{0.6}P_{0.4}O₄.

From the viewpoint of flexibility, etc., of the solid electrolyte layer, the solid electrolyte layer preferably contains a binder. As the binder, for example, there may be mentioned a fluorine resin such as polyvinylidene fluoride (PVDF) and a rubbery resin such as styrene-butadiene rubber (SBR).

In the solid electrolyte layer, the ratio of the components constituting the solid electrolyte layer is not particularly limited. For example, the solid electrolyte contained in the solid electrolyte layer is preferably 50 to 100 wt %, more preferably 90 to 100 wt % of the whole solid electrolyte layer. The binder is preferably 0.01 to 20 wt %, more preferably 0.1 to 5 wt % of the whole solid electrolyte layer.

The thickness of the solid electrolyte layer is not particularly limited. In general, it is preferably 5 to 300 μm.

In addition to the positive electrode layer, the solid electrolyte layer and the negative electrode layer, the electrode unit generally further comprises a positive electrode current collector for collecting current from the positive electrode layer, and a negative electrode current collector for collecting current from the negative electrode layer.

The material of each current collector is not particularly limited. For example, there may be metals such as stainless steel, Cu, Ni, V, Au, Pt, Al, Mg, Fe, Ti, Co, Zn, Ge, In and Li. A substrate can be also used as the current collector, which is obtained by vapor-deposition of one or more of the metals on a surface of a glass plate, a silicon plate or a resin substrate of polyamide, polyimide, PET (polyethylene terephthalate), PPS (polyphenylene sulfide), polypropylene, etc. The thickness of the current collector is not particularly limited. In general, it is preferably in the range of 10 to 500 μm.

The shape of the electrode unit is not particularly limited and can be appropriately selected.

The method for producing an electrode unit is not particularly limited. For example, each of the positive and negative electrode layers can be produced by applying and drying an electrode paste (positive electrode material paste/negative electrode material paste) which is prepared by dispersing in a solvent an electrode layer-constituting component (electrode material powder) containing an electrode active material and, as needed, a solid electrolyte, a binder, a conductive additive, etc. The solid electrolyte layer can be produced by applying and drying a solid electrolyte material paste prepared by dispersing in a solvent an electrolyte layer-constituting component (solid electrolyte powder) containing a solid electrolyte and, as needed, a binder, etc.

The solvent for the electrode material paste or solid electrolyte paste is not particularly limited as long as it can disperse an electrode material powder or electrolyte powder. For example, there may be mentioned a saturated hydrocarbon-based solvent, an aromatic hydrocarbon-based solvent and water. The solid content ratio of the electrode material paste and that of the electrolyte paste can be adjusted appropriately, considering coating properties thereof. In general, they are preferably in the range of 40 to 60%.

The surface to which the electrode material paste or solid electrolyte material paste will be applied varies depending on the thus-employed electrode unit production method. For example, there may be mentioned a surface of a current collector, solid electrolyte layer or electrode layer which is adjacent to an electrode layer or solid electrolyte layer to be formed. Also, the electrode material paste or electrolyte material paste can be applied to a surface of a substrate for forming the electrode layer or for forming the solid electrolyte layer. The method for applying the paste is not particularly limited, and there may be used any method such as a doctor blade method, die coating method or gravure coating method.

Other than the above-described method for forming the electrode layer from the paste, the positive and negative electrode layers can be produced by pressure-forming the electrode material powder by a powder forming method. Similarly, the solid electrolyte layer can be produced by pressure-forming the electrolyte powder by a powder forming method.

The electrode cell can comprise a stack of the electrode units. A solid-state battery with desired battery properties can be obtained by stacking a plurality of electrode units and electrically connecting them. Also in the present invention, in the case where the electrode cell comprises a stack of a plurality of electrode units, pressing of the electrode units constituting the stack, especially pressing and heating the same, can be performed at once; therefore, compared with the case of pressing or pressing and heating every electrode unit, it is possible to decrease the number of solid electrolyte battery production steps and thus to increase solid electrolyte battery productivity.

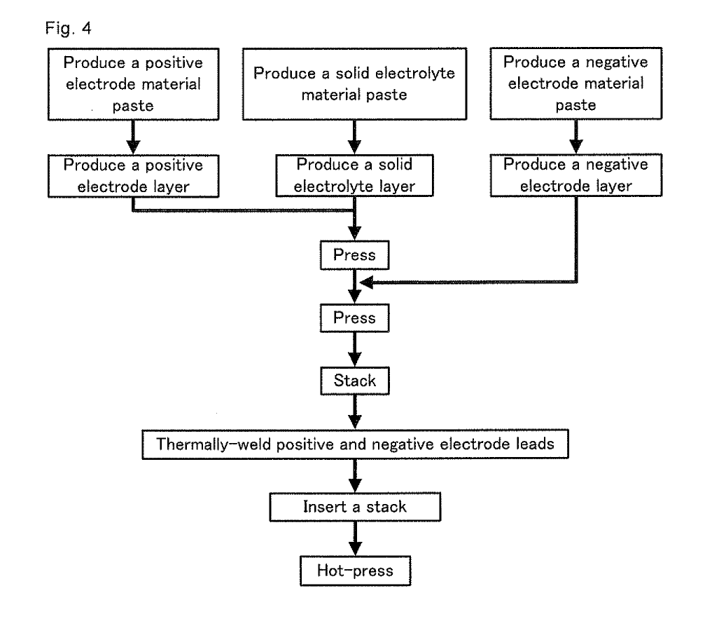

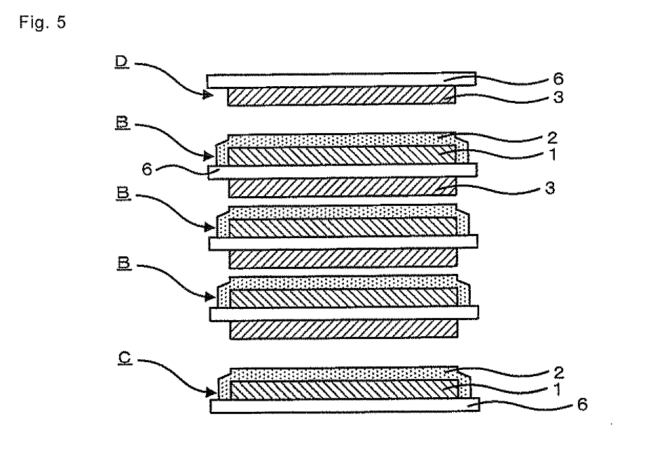

Hereinafter, an example of the specific method for producing the electrode cell comprising a stack of electrode units, will be explained by way of FIGS. 4 and 5. FIG. 4 is a flowchart of the production flow of the electrode cell comprising such a stack. FIG. 5 is a view showing an example of the method for producing a stack using electrode units. In the present invention, the method for producing the electrode unit and stack is not limited thereto.

A positive electrode material paste is prepared in the following manner. First, a mixture is prepared by dry mixing a positive electrode active material (e.g., LiCoO₂), a solid electrolyte (e.g., Li₂S-P₂S₅), a conductive additive (e.g., acetylene black) and a binder (e.g., SBR) at a desired ratio (e.g., 45 wt %:45 wt %:7 wt %:3 wt %). A solvent (e.g., heptane) is added thereto so as to have a desired solid content ratio (e.g., 50 wt %) and wet-kneaded, thereby preparing a positive electrode material paste. The paste is applied to a surface of current collector (e.g., a 15 μm-thick SUS foil) 6 by a doctor blade method and dried at 80° C., thereby forming positive electrode layer 1.

A solid electrolyte material paste is prepared by the following manner. First, a mixture is prepared by dry mixing a solid electrolyte (e.g., Li₂S-P₂S₅) and a binder (e.g., SBR) at a desired ratio (such as 95 wt %:5 wt %). A solvent (e.g., heptane) is added thereto so as to have a desired solid content ratio (e.g., 50 wt %) and wet-kneaded, thereby preparing a solid electrolyte material paste. The paste is applied to a surface of positive electrode layer 1 by a doctor blade method and dried at 80° C., thereby forming solid electrolyte layer 2. At this time, by applying the solid electrolyte material paste so as to extend beyond the outer rim of positive electrode layer 1, it is possible to prevent the occurrence of a short circuit in positive electrode layer 1 and negative electrode layer 3.

Electrode member A (current collector-positive electrode layer-solid electrolyte layer) produced as explained above is preferably pressed in the stacking direction of the layers. This is because it is possible to make the applied surface flat and smooth by pressing them, and it is thus possible to decrease variation in charge and discharge by reducing coating non-uniformity. The pressure condition of the pressing is not particularly limited. In general, it is preferably 1.0×10⁶ to 1.0×10⁹ Pa.

A negative electrode material paste is prepared in the following manner. First, a mixture is prepared by dry mixing a negative electrode active material (e.g., Li₄Ti₅O₁₂), a solid electrolyte (e.g., Li₂S-P₂S₅), a conductive additive (e.g., acetylene black) and a binder (e.g., SBR) are mixed at a desired ratio (e.g., 45 wt %:45 wt %:7 wt %:3 wt %). A solvent (e.g., heptane) is added thereto so as to have a desired solid content ratio (e.g., 50 wt %) and wet-kneaded, thereby preparing a negative electrode material paste. The paste is applied to a surface of current collector 6 of electrode member A (a surface which is opposite to one on which positive electrode layer 1 and solid electrolyte layer 2 are formed) by a doctor blade method and dried at 80° C., thereby forming negative electrode layer 3.

Bipolar electrode B (negative electrode layer 3-current collector 6-positive electrode layer 2-solid electrolyte layer 1) produced as explained above is preferably pressed in the stacking direction of the layers. This is because it is possible to make the applied surface flat and smooth by pressing them, and it is thus possible to decrease variation in charge and discharge by reducing coating non-uniformity. The pressure condition of the pressing is not particularly limited. In general, it is preferably 1.0×10⁶ to 1.0×10⁹ Pa.

In addition to bipolar electrode B, electrode member C and electrode member D are produced. Electrode member C comprises current collector 6, positive electrode layer 1 and solid electrolyte layer stacked in this order (current collector 6-positive electrode layer 1-solid electrolyte layer 2). Electrode member D comprises current collector 6 and negative electrode layer 3 stacked in this order (current collector 6-negative electrode layer 3). Electrode member C can be produced in the same manner as that of electrode member A in the above-described bipolar electrode production. Electrode member D can be produced by, in the above-described bipolar electrode production, forming the negative electrode layer on a surface of a metal foil (current collector) on which no positive electrode layer and no solid electrolyte layer are formed.

A stack comprising (N+1) electrode units can be produced by sandwiching N (a desired number) bipolar electrodes B by electrode member C (current collector-positive electrode layer-solid electrolyte) and electrode member D (current collector-negative electrode layer). At this time, electrode member C, N bipolar electrodes B and electrode member D are stacked so that current collector 6 of electrode member C and that of electrode member D become outermost layers of the stack. Each of positive and negative electrode leads (not shown in FIG. 5) can be fixed to each of the two outermost current collectors by welding. The welding position of the positive and negative electrode leads are not particularly limited.

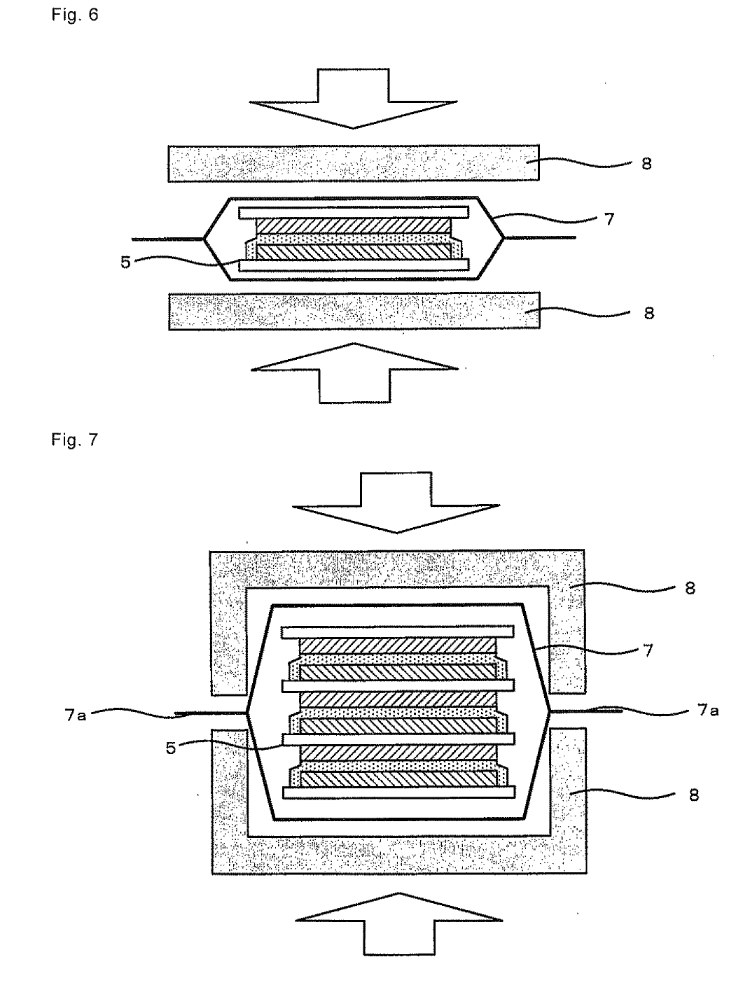

In the above-described bipolar electrode production, the solid electrolyte layer is formed on the positive electrode layer; however, it can be formed on the negative electrode layer. Also in the bipolar electrode production, the positive and negative electrode layers are formed on the same current collector; however, they can be formed on different current collectors. Also in the bipolar electrode production, the negative electrode layer is formed on a surface of the current collector; however, it can be formed on a surface of the solid electrolyte layer. Other than the stack of a plurality of electrode units as described above, the electrode cell can be one comprising one electrode unit (see FIG. 6).

### (2) Pressing Step

The electrode cell inserted and thus housed in the outer case in the housing step, is pressed from the outside of the outer case in the stacking direction in the electrode unit.

The pressure in the pressure treatment of the pressing step is not particularly limited. In general, it is preferably in the range of 1.0×10⁶ to 1.0×10¹⁰ Pa.

As explained above, the structure of the electrode cell, which is an object of the pressing, can be one having a stack of a plurality of electrode units stacked as shown in FIG. 1 or one having one electrode unit as shown in FIG. 6.

Preferably, the electrode cell is pressed and at the same time heated in the pressing step. The constituents of the electrode unit of the electrode cell, more specifically, the solid electrolyte contained in the solid electrolyte layer and electrode layers is softened, thereby increasing the adhesion between the constituents of the electrode unit and the ion conductivity and electrical conductivity of each layer. Also in the case of heating the electrode cell concurrently with pressing the same, the metal of the current collectors constituting the electrode cell is likely to produce a burr, and there is a problem such that the burr thus produced attaches to the pressing surface and then attaches to the electrode cell subsequently pressed, thereby causing a small short circuit. In the present invention, however, the electrode cell is inserted in the outer case in the pressing step, so that it is possible to prevent a small short circuit due to such an electrically-conductive, foreign substance.

In the pressing step, the heating temperature is needed to be able to soften the solid electrolyte contained in the electrode cell. The heating temperature is not particularly limited as long as it is the same as or more than the softening point of the solid electrolyte, and the heating temperature is varied depending on the used solid electrolyte. In general, it is preferably 150° C. or more, more preferably 180° C. or more, and still more preferably 190° C. or more. On the other hand, from the viewpoint of the melting temperature of the heat-resistant resin, it is preferably 300° C. or less, more preferably 250° C. or less, and still more preferably 230° C. or less.

In the case where the electrode cell is pressed and at the same time heated in the pressing step, the outer case can be sealed by thermofusion at the same time as pressing and heating the electrode cell. As just described, by allowing the pressing step to double as the sealing step, it is possible to decrease the number of the solid electrolyte battery production steps and thus to increase solid electrolyte battery productivity. In the case of sealing the outer case in the pressing step, a sealing portion of the outer case is heated at a temperature at which the sealing portion can be sealed by thermofusion. For example, the sealing portion of the outer case is heated at a temperature that is more than the melting temperature of the thermally-weldable resin layer constituting the outer case.

As just described, in the case of sealing the outer case in the heating step concurrently with pressing and heating the electrode cell, one which is sealable by thermofusion at the heating temperature of the electrode cell is used as the outer case.

Also in the case of sealing the outer case in the pressing step, it is possible to press the electrode cell in the stacking direction in the electrode unit and, at the same time, it is possible to press and heat sealing portion 7a of the outer case 7 by using, for example, pressing machine 8 which has a pressing surface as shown in FIG. 7.

### (3) Other Steps

In addition to the above-described steps, the solid electrolyte battery production method of the present invention can have other steps.

For example, there may be mentioned a step of sealing the outer case. As described above, because the pressing step doubles as the sealing step, there is an effect of increasing battery productivity. In the case of separately providing a sealing step between the inserting step and the pressing step, there is an effect of decreasing the possibility of bringing the electrode cell into contact with moisture. Deterioration of the constituents of the electrode cell is promoted by contact of the electrode cell with moisture in the air, resulting in a decrease in battery performance. Especially in the case where moisture is present at the time of pressing and heating the electrode cell, there is a larger decrease in battery performance.

It is possible to reduce or avoid the contact of the electrode cell with moisture by sealing the outer case at the earliest possible stage after inserting the electrode cell in the outer case, that is, especially after inserting the electrode cell in the outer case and before pressing and heating the electrode cell. Also, there is an advantage that it is possible to ease the condition of a post sealing step after the sealing step by sealing the outer case at the early stage. Moreover, in the case of using a sulfide-based compound as the solid electrolyte, especially because the degree of a decrease in battery performance due to the contact of the electrode cell with moisture, is large, environmental control is easy in the production process and product cost reduction is possible.

### REFERENCE SIGNS LIST

1. Positive electrode layer

2. Solid electrolyte layer

3. Negative electrode layer

4. Electrode unit

5. Electrode cell

6. Current collector

7. Outer case

7a. Sealing portion

8. Pressing machine

9. Stack

10. Heat-resistant member

B. Bipolar electrode

C. Electrode member

D. Electrode member

1. A method for producing a solid electrolyte battery in which an outer case houses at least one electrode cell that has an electrode unit comprising at least a positive electrode layer, a solid electrolyte layer and a negative electrode layer stacked in this order, the method comprising the steps of:
inserting the electrode cell in the outer case before pressing the electrode cell in a stacking direction in the electrode unit,
pressing the electrode cell from the outside of the outer case in the stacking direction in the electrode unit, and
sealing the outer case,
wherein a heat-resistant member which prevents the electrode cell from reaching a heating temperature in the sealing step, is present between the outer case and the electrode cell.

2. The method for producing the solid electrolyte battery according to claim 1, wherein the electrode cell comprises a stack of the electrode units.

3. The method for producing the solid electrolyte battery according to claim 1, wherein the electrode cell is pressed and at the same time heated in the pressing step.

4. The method for producing the solid electrolyte battery according to claim 3, wherein the pressing step doubles as a step of sealing the outer case.

5. The method for producing the solid electrolyte battery according to claim 1, wherein the step of sealing the outer case is present between the inserting step and the pressing step.

6. (canceled)

7. The method for producing the solid electrolyte battery according to claim 2, wherein the electrode cell is pressed and at the same time heated in the pressing step.

8. The method for producing the solid electrolyte battery according to claim 2, wherein the step of sealing the outer case is present between the inserting step and the pressing step.

9. The method for producing the solid electrolyte battery according to claim 3, wherein the step of sealing the outer case is present between the inserting step and the pressing step.

10. The method for producing the solid electrolyte battery according to claim 7, wherein the step of sealing the outer case is present between the inserting step and the pressing step.

11. The method for producing the solid electrolyte battery according to claim 7, wherein the pressing step doubles as a step of sealing the outer case.
